(19) United States
(12) Patent Application Publication
(10) Pub. No.: US 2015/0016095 A1
(43) Pub. Date: Jan. 15, 2015

(54) Garment with illuminate safety features

(71) Applicant: George Kretzu, Wall, NJ (US)

(72) Inventor: George Kretzu, Wall, NJ (US)

(21) Appl. No.: 13/987,171

(22) Filed: Jul. 9, 2013

(51) Int. Cl. F21V 33/00; A41D 1/00

(52) U.S. Cl. CPC F21V 33/0076; A41D 1/002
USPC 362/108

(57) ABSTRACT

A garment with illuminate safety features and a power source which allows the wearer to selectively set the frequency of the illuminate safety features so as to identify the location of the wearer and serve to warn other individuals or vehicles as to the wearer's location, the illuminate safety features in the form of removable LED strips positioned within channels secured to the garment and which allow for the removal thereof for the cleaning of the garment, the activation of such illumination device can be accomplished by remote control.

### RELATED APPLICATIONS

Applicant claims the benefit of provisional application Ser. No. 61/741,045, filed Jul. 12, 2012.

### BACKGROUND OF THE INVENTION

1. Field of the Invention

The present invention relates to clothing, and more particular, to an outer garment such as a jacket, vest or shirt which may have illuminating safety features positioned on the arms and torso of the garment, the illumination safety features being LEDs powered by a rechargeable power supply incorporated into the garment which may be remote controlled.

2. Description of the Prior Art

Motorcyclists suffer an inordinate percentage of injuries and fatalities in the operation of their motorcycles. In daylight and high visibility situations, the drivers of automobiles oftentimes are not looking for a motorcyclist or not paying attention, and as a result of their operation of the automobile, they collide with a motorcyclist. In many situations, the motorcyclist is at fault for attempting to execute a dangerous maneuver in high capacity vehicular traffic.

However, the motorcyclist is most at danger in low visibility and dark situations. The motorcyclist has a forward oriented headlight and rear taillights, stop lights and turn signals. However, the motorcyclist is almost invisible to a vehicle such as an automobile approaching the motorcycle from the side. Such a situation arises at any intersection in which the motorcycle is traveling in one direction and automobiles are traveling in a transverse direction. The driver of the automobile cannot detect the motorcyclist until the motorcyclist becomes lit by the headlights of the automobile. In many instances, this does not provide sufficient reaction time to the operation of the automobile. The motorcyclist can put reflective tape on the sides of the motorcycle and can put reflective tape on his helmet, but in both instances, the reflection is not registered until the headlights of the approaching vehicle reflect off of it.

Applicant has addressed this issue with a garment worn by the motorcyclist. The garment in a motorcyclist's situation would be a jacket or vest in which the arms or the side torso areas were constructed with channels in which LED strips were positioned. The LED strips would be secured to a self-contained rechargeable lithium ion battery in a pocket of the garment, or by means of a detachable harness, the LED strips could be plugged into a harness in cooperation with the battery of the motorcycle. These LED strips which would run from the armpit to the waist on the garment, or from the shoulder to the wrist on the arms of the garment would light intermittently or continuously at the selection of the cyclist and would be visible to automobiles and other vehicles which might approach the motorcycle in a transverse direction, such as at intersections. The orientation of the motorcyclist's body while operating the motorcycle would therefore present a vertical lit line from the armpit to the waist and a generally horizontal lit line from the shoulder to the wrist, as the arms of the motorcyclist grasp the handlebars. A jacket of the type described would be sufficient to get the attention of drivers of automobiles approaching a motorcyclist transversely. Additionally, in inclement weather, the motorcyclist may also wear a pair of protective leggings. These leggings could also be incorporated with the LED strips positioned in channels along the outer portion of the legs.

The garment previously described was developed as a result of specific motorcycle experiences. However, in fabricating prototypes, it became apparent that such an illuminated garment and its harness could have application to other situations in which individuals in performing their duties or employment, find themselves in dangerous situations. One such occupation is that of an aircraft ground director. This individual directs air traffic on taxiways through the use of two hand-held illuminated wands which he holds in each hand and through hand signals, transmits directions to the pilot of an aircraft who may be sitting 30 feet above him in the cockpit. At night and in inclement weather, this individual may not be as visible as desired irrespective of the illuminated wands and possible reflective gear. A jacket of the type previously described with the LED strips and channels positioned on the arms of such a garment would have the effect of sending the lit illuminating hand wands down the arms of the aircraft ground director, thus presenting two, approximately 3 feet long light patterns to the aircraft crew.

Another occupation in which a garment of the type described would be beneficial to the safety of the individual is that of a police patrol officer. In situations of darkness or low visibility, the patrol car is always visible because of the flashing lights that are affixed to the vehicle. However, in low visibility and darkness, the police patrol office who rides in the vehicle is oftentimes exterior of the vehicle dealing with an automobile which he has pulled to the side of the road. In this instance, an oncoming driver can readily see the police vehicle, but may not readily see the police officer. A garment of the type described with LED strips extending down the arms, would identify the location of the officer and would serve to get the attention of oncoming drivers.

A still further occupation would be that of the fireman and the bunker coats which they are required to wear when fighting fires. Firemen almost always perform in situations of low visibility caused by smoke and a careful choice of the LED strips and their color in conjunction with a bunker coat for a fireman would insure that the firemen would be visible in low visibility situations such as smoke, etc., even if there was a background of bright lights, such as a fire.

A still further occupation which would benefit from a garment of the type described is that of construction and maintenance personnel who work on or near, or work proximate to highways in which there is a high volume of vehicular traffic. During daylight these individuals are normally required to wear hard hats and high visibility vests. However, in many instances, they do not work strictly during the daylight hours and are oftentimes called out to make repairs in the event of accidents or the like. Such a situation, a garment of the type described could be worn by the construction or maintenance personnel which would again serve to identify their location and also be visible to a driver of a vehicle from a distance greater than the vehicles headlights so that the vehicles driver would be alert to personnel and individuals proximate the highway.

### OBJECTS OF THE INVENTION

An object of the present invention is to provide for a garment which includes illuminated safety features in the form of LED strips which are powered by a self-contained, rechargeable lithium ion battery affixed to the garment on an automotive or non-automotive 12 v power source or bicycle generator.

A further object of the present invention is to provide for a garment with illuminate safety features, which garment can include an electrical harness which can be plugged in to take advantage of the battery of the vehicle for illumination, such vehicle being a motorcycle or a tire generator on a motorcycle.

A still further object of the present invention is to provide for a garment with illuminate safety features which allow the user/wearer to control and selectively set the lighting sequence and frequency, i.e. steady or blinking.

A still further object of the present invention is to provide for a garment with illuminate safety features which includes a plurality of LED strips attached to an electrical harness secured to the electrical source of a motorcycle, the LED strips reacting to the controls of the motorcycle, such that the LED strips on the garment blink as an indicator of turns or stops.

A still further object of the present invention is to provide for a novel garment with an illuminate safety feature in which the LED strips and power source can be easily removed from their channels for the cleaning of the garment.

A still further object of the present invention is to provide for a garment with illuminate safety features in which the garment can be secured to a recharger when not in use.

### SUMMARY OF THE INVENTION

A garment with illuminate safety features and a power source which allows the wearer to selectively set the frequency of the illuminate safety features so as to identify the location of the wearer and serve to warn other individuals or vehicles as to the wearer's location, the illuminate safety features in the form of removable LED strips positioned within channels secured to the garment and which allow for the removal thereof for the cleaning of the garment, the activation of such illumination device can be accomplished by remote control.

### BRIEF DESCRIPTION OF THE DRAWINGS

These and other objects of the present invention will become apparent, particularly when taken in light of the following illustrations wherein:

FIG. 1 is a side view of a motorcycle and motorcyclist;

FIG. 2 is a front view of the garment of the present invention;

FIG. 3 is a side view of the garment of the present invention;

FIG. 4 is a rear view of the garment of the present invention and battery back;

FIG. 5 is a close-up perspective view of a first embodiment of the channels secured to the garment for housing the illumination source;

FIG. 6 is a cross section view along Plane 6-6 of FIG. 6 of the channels secured to the garment for securing the illumination source;

FIG. 7 is a rear view of a second embodiment of the garment of the present invention for particular use by motorcyclists in order to tap into the power source of the motorcycle which electrical harness provides for additional features for a garment worn by a motorcyclist; and

FIG. 8 is a perspective view of an motorcycle or bicycle rider wearing a still further embodiment of the garment of the present invention which has now been reduced to a suspender-like illuminating garment for reduced weight and for use in hot weather.

### DETAILED DESCRIPTION OF THE INVENTION

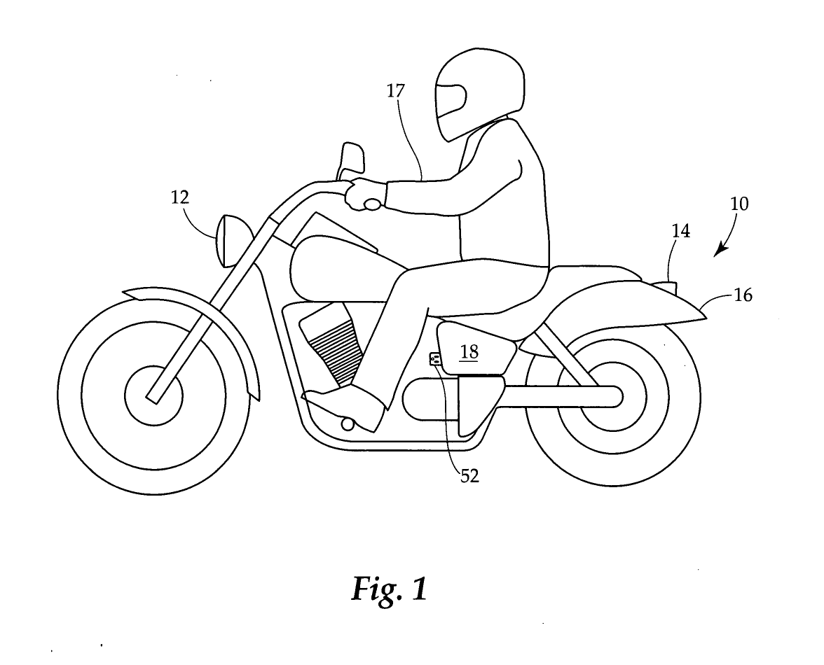

FIG. 1 is a side view of a motorcyclist. The motorcycle 10 itself is equipped with a forward oriented headlight 12 and tail lights and brake lights 14 positioned on the rear fender 16. The motorcyclist sits between these two light sources and as is obvious, the light sources are designed for seeing what is in front of the motorcycle as it approaches and for warning vehicles behind the motorcyclist of his actions. There is nothing on the side to warn or alert drivers who are traveling transversely to the direction of the motorcyclists, such as at an intersection. The first warning or inkling that a motorcyclist is crossing in front of him occurs when the driver of the vehicles headlights reach the motorcyclist and he becomes visible to the automobile driver. Even if reflective decals 18 or the like were placed on strategic positions on the side of the motorcycle, these would not become visible to the driver of an automobile until the vehicle's headlights reflected off of them, which in many instances would be too late.

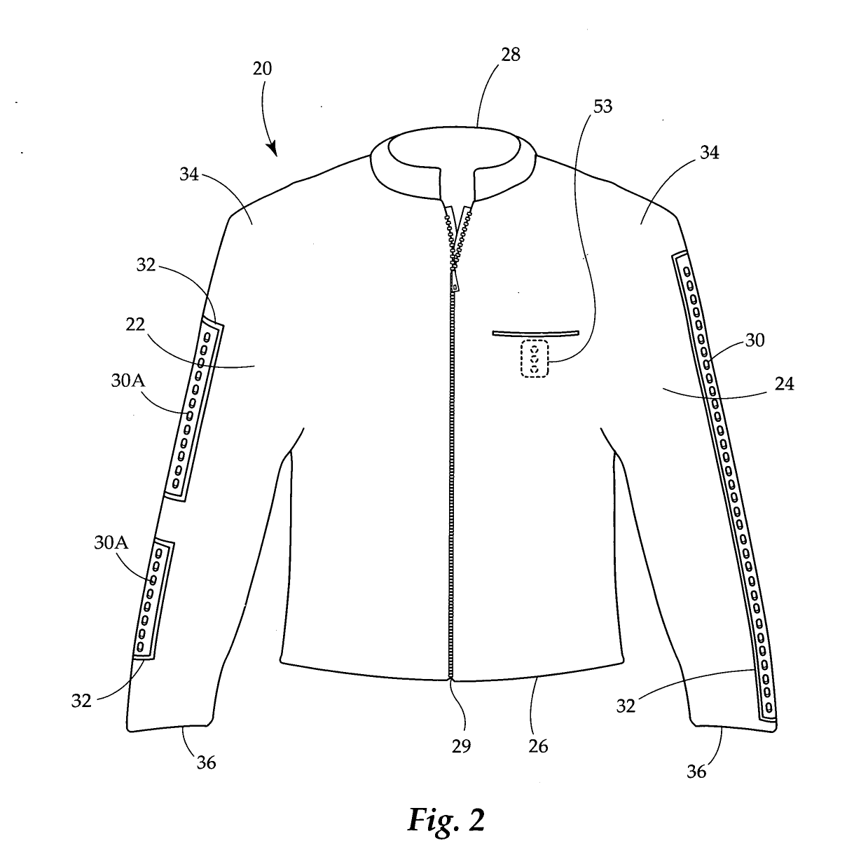

FIGS. 2, 3, and 4 are front, side, and rear views of a garment of the present invention in the form of a jacket, which could be worn by the motorcyclist and which could provide warnings to the vehicles traveling in a transverse direction to the motorcyclist. The jacket 20 would be of conventional construction having arms 22 and 24, waist 26, neck 28, and a front closure 30. The modification to the jacket 20 would be the incorporation of a plurality of LED strips 30 positioned within channels 32, the channels 32 being strategically placed on the jacket to provide maximum visibility to either side of the motorcyclist when positioned on the motorcycle as illustrated in FIG. 1. The front view of garment 20 illustrates a continuous channel 32 extending down the left arm of garment 20 from the shoulder area 34 to the wrist area 36. When activated, the LED strips 30 within channel 32 would be selectively set to either be lit continuously or to blink intermittently. In actual practice, it has been found that it is perhaps the preferred embodiment to have two separate LED strips 30A as illustrated in FIG. 2 with respect to the right arm of the jacket. One strip positioned above the elbow, and the other strip positioned below the elbow. This allows for free movement of the arm at the elbow without infringing upon the effectiveness of the LED strips. The LED strips 30 or 30A would normally present a generally horizontal lighting picture to automobiles approaching the motorcyclists from the sides, because the LED strips 30 or 30A would be oriented down the back of the arm of the garment since this represents the transverse exposed area when the motorcyclist grips the handle bars as illustrated in FIG. 1. This was due to the fact that the motorcyclist's hand would normally be on the handlebars of the motorcycle with the arms outstretched 17 as shown in FIG. 1, and thus in a horizontal position perpendicular to the torso.

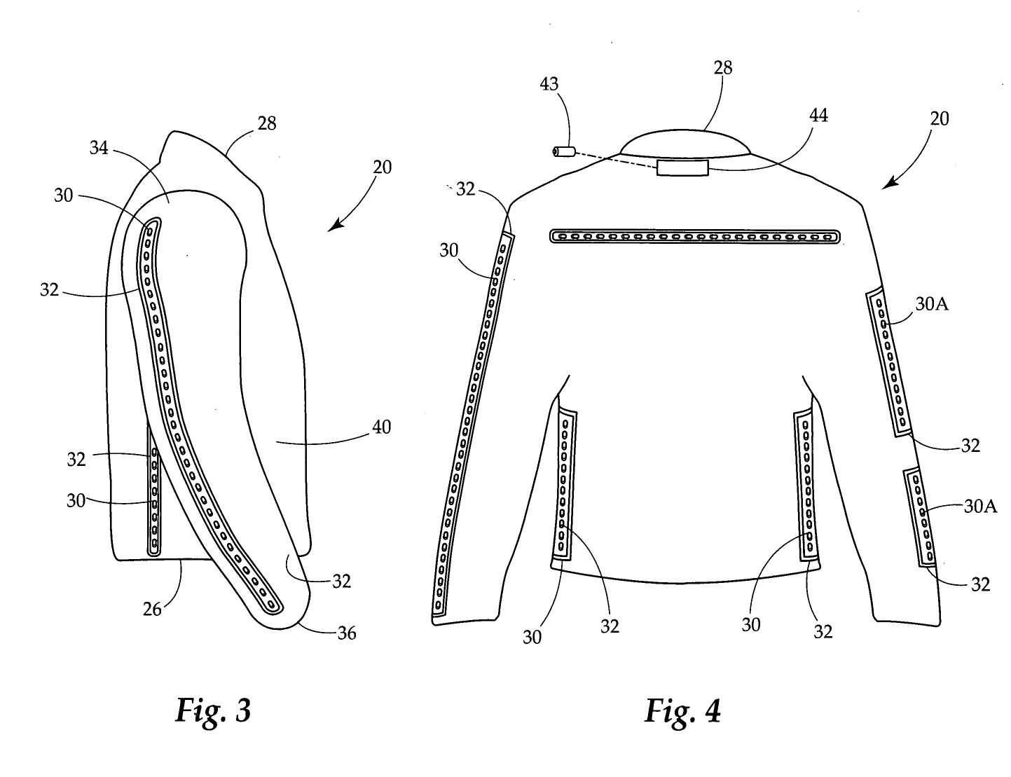

FIG. 3 illustrates an additional positioning pattern for the LED strips 30 in channels 32 formed on the torso sides 40 of the garment between the armpit and the waist 26. This area would be visible when the motorcycle is being operated since the motorcyclist's arms 17 would be in a substantially horizontal position as previously mentioned, thus exposing the torso. An LED strip 30 in this location on each side of the garment would present a vertical illuminated line or intermittent line to vehicles approaching transversely to the direction of the motorcyclists or even to vehicles approaching from the rear.

FIG. 4 is a rear view of the garment of the present invention illustrating a pocket 44 formed near the neck or collar 28 of the garment which pocket would encapsulate a rechargeable power source, such as a lithium ion battery 43. The location of the power source at the rear of the jacket in the neck region provides for ease of connection with respect to the location of the LED strips 30 and the channels 32 be they on the arms of the garment or on the sides of the torso. The positioning of pocket 44 at this location allows for the wiring connections for the various LED strips 30 and 30A to be positioned on the interior of garment 20.

FIG. 4 also illustrates another embodiment of the invention in which additional channel 32 extends across the back of the garment with LED strips 30 contained therein. FIG. 4 illustrates this channel 32 across the back of the garment as being independent from the other channels, however, it could be an extension from either a panel 30 or 30A as illustrated on the arms of the garment without departing from the spirit and scope of the invention.

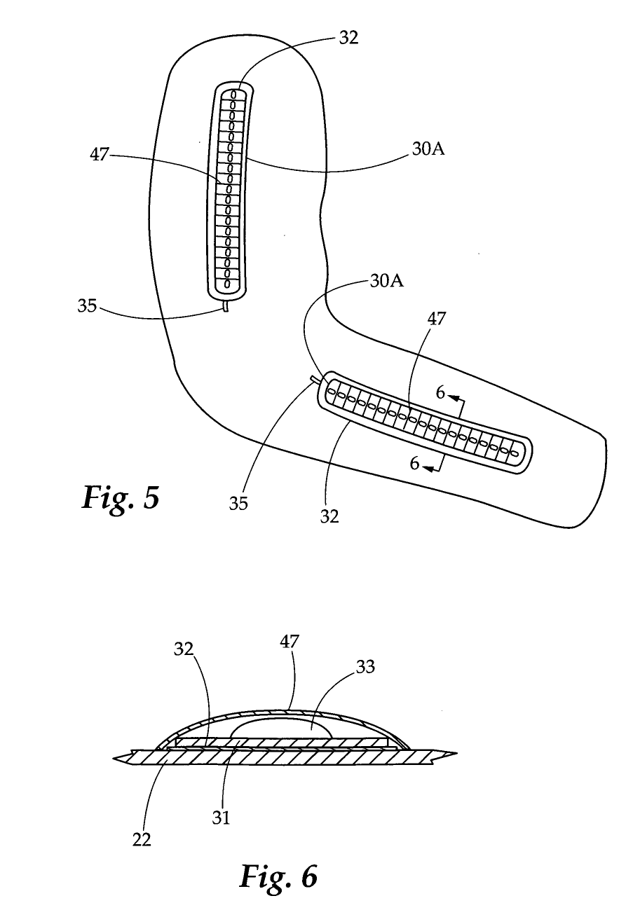

The channels 32 and the LED strips 30A are more clearly illustrated in FIGS. 5 and 6. FIG. 5 is a perspective view of the right arm of the garment as illustrated in FIG. 2. It contains two channels 32, one above the elbow and one below the elbow. In the embodiment illustrated in FIG. 5, the channels are defined by a woven mesh fabric or webbing 47 secured to the outer surface of the left arm of the garment. The mesh fabric or webbing 47 forms a channel into which an LED strip 30A may be slidably inserted. The LED strip 30A comprises a support strip 31 which has secured thereto a plurality of LEDs 33. The LED strip 30A above the elbow is secured by a wire 35 to the LED strip 30A below the elbow. This connecting wire is preferably positioned through an aperture in the fabric so that its length is substantially contained within the garment.

FIG. 6 is a cross sectional view of the structure along Plane 6-6 of FIG. 5. The fabric of the left arm 22 forms the base. The mesh fabric 47 forming the channel 32 is secured to the outer surface of the fabric of the left arm 22. This could be secured by sewing, adhesive, heat sealing or the like. The mesh fabric forms the channel 32 into which the LED strip 30A is inserted, the LED strip 30A having a plurality of LEDs 33 secured to its support strip 31 thereto and in electronic communication with the upper LED strip 30A above the elbow and subsequently in communication with the power source positioned within pocket 44 as illustrated in FIG. 4.

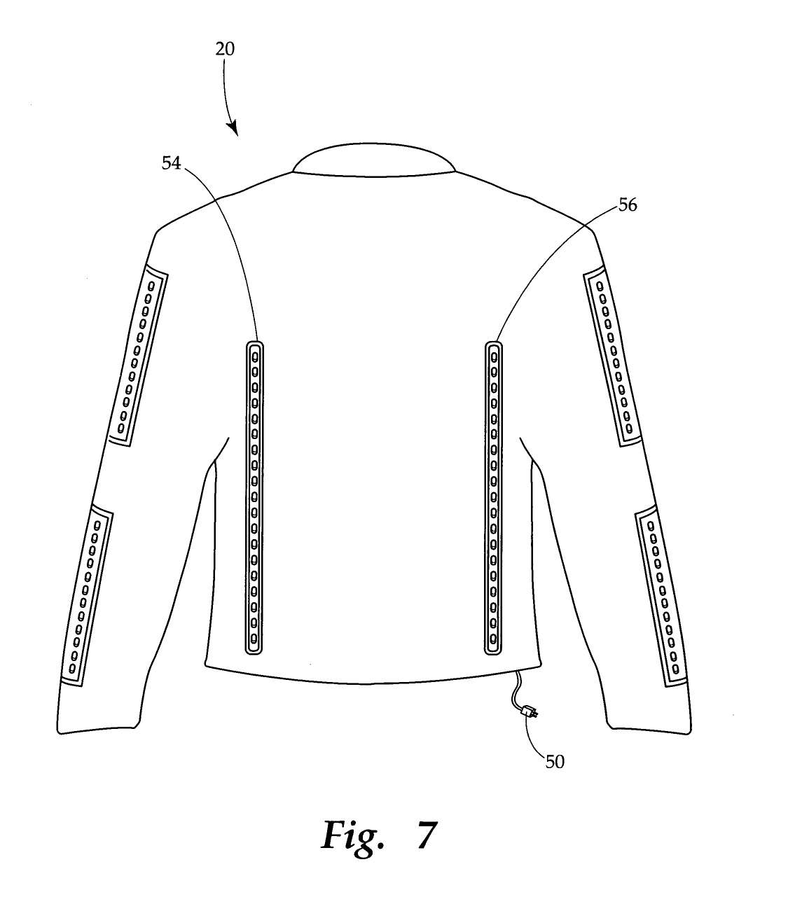

FIG. 7 is a rear view of a second embodiment of the garment 20 of the present invention. It is identical to the garment illustrated in FIGS. 2, 3 and 4, and the channels are the same as those illustrated in FIGS. 5 and 6. The difference with respect to the embodiments shown in FIG. 7, is that it is wired to an electrical harness 50, which electrical harness is compatible with a receptacle 52 (See FIG. 1) on motorcycle 10, as illustrated in FIG. 1. This allows the cyclist to plug the garment into the receptacle 52 and draw power from the motorcycle to power the various LED strips. In addition, the garment 20 illustrated in FIG. 7 contains two additional LED strips and channels 54 and 56 located on the back panel of the garment. These two strips are in synchronation with the electronics of the motorcycle, such that when the operator signals a left hand turn and the rear tail light blinks for a left hand turn, the strip on the left side of the torso will also blink in synch with the taillight. The same would hold true for a right hand turn and the right hand LED strip on the right side of the torso. These strips would also light up in a permanent fashion if the operator applied the brakes. The entire garment can be operated by remote control 53 using a 12 volt direct current control unit which is similar in size to that attached to a standard automobile key. The remote control 53 would be in communication with the electronics and mounted conveniently on the front of the garment. (See FIG. 2) Further, the power pack located in pocket 44 could be a rechargeable lithium ion battery, and a recharger harness could be included within the pocket which allowed the easy and quick removal and attachment to a recharge power source for that battery. Choice of the color for the actual LED is one of preference. White LEDs might be used on the arms of the garment, while red or amber LEDs would be used on the LED strips located on the rear of the garment as illustrated in FIG. 7 to match the color of the tail lights.

The garment has been described in its preferred embodiment as it related to motorcyclists and a motorcycle jacket. However, it will be recognized that motorcyclists do not always wear a jacket, depending upon the climate and the weather. Many times just a shirt is worn, or a vest. The application of Applicant's illumination process for motorcyclists has application to whatever garment the motorcyclist is wearing in order to provide additional safety to the motorcyclist and visibility to surrounding automobile drivers.

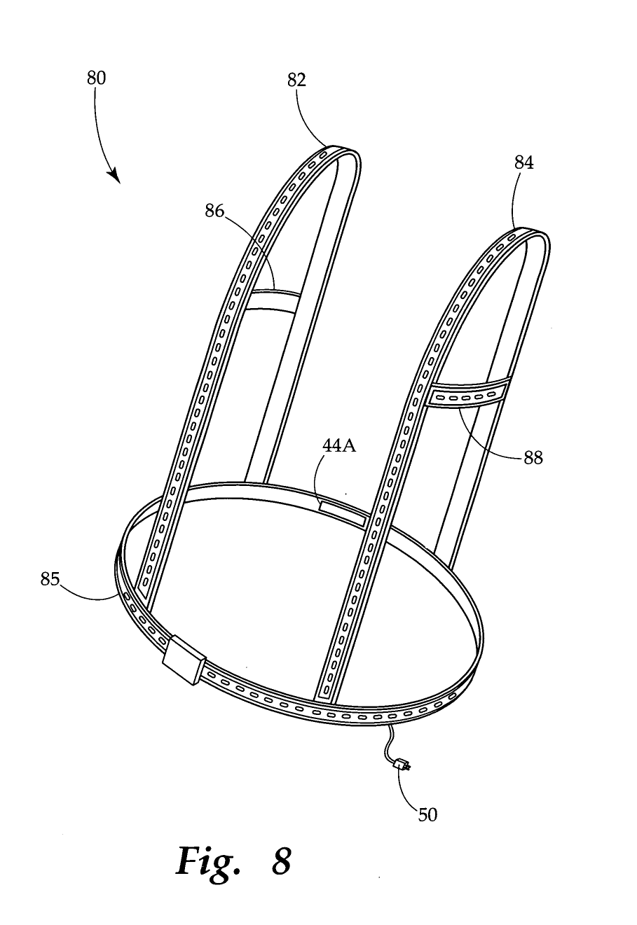

FIG. 8 illustrates a hot weather illuminated garment for use by motorcyclists or bicyclists. It works upon the same principal as the jacket, however it consists merely of a suspender-like garment 80 having straps 82 and 84 which extend over the shoulders of the rider and depend along the rider's back and along the rider's front torso, and secured to belt 85, as well as optional straps 86 and 88 which extend about the side rib cages of the rider under the arms to provide illumination for vehicles which may be approaching transversely to the direction of the motorcyclist or the cyclist. The channels and the construction of the LEDs is identical to that of the jacket heretofore described. In addition, the suspender-like garment may be powered by a rechargeable lithium ion battery contained within a pocket 44A, or it may have the same type of harness 50 as the jacket for use by the motorcyclist with respect to the electrical power supply for the motorcycle, or by the bicyclist with respect to a generator secured to and run off a wheel of the bicycle.

It will also be recognized that while the illuminate garment has been described with respect to a jacket, vest, or shirt, the same illumination can be appended to overalls or pants worn during inclement weather by a motorcyclist. In such an instance, the illuminated LED strips would be slidably received along the outside seam of the pants to be viewable from vehicles approaching transversely to the cyclist. These pants could be battery operated or also be secured to the harness of the motorcyclist and run off of the battery of the motorcycle. Still further, the garment as described herein may also have application to bicyclists and may be worn by bicyclists utilizing batteries and rechargeable batteries. It may also be used by bicyclists who have a wheel mounted generator which would allow for a harness to be secured thereto such that the illuminated garment would be powered from the generator.

Still further, as pointed out previously, the concept for the garment was originally developed for motorcyclists. However, during the development, it became apparent that the garment or similar garment would have application to other professionals such as police officers and the like which have been enumerated previously. In such a situation the illumination garment would provide additional safety features. Still further, in certain of those occupations, the illumination of Applicant's invention may be utilized to actually spell out the occupation of the wearer. As an example, the LEDs could be arranged across the back of the garment to spell “POLICE”.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A motorcycle garment with illumination safety features to identify the location and direction of travel of a motorcycle rider, the garment comprising:
a garment formed with a front panel, rear panel, and side panels covering the torso of the rider, there being two arms for the insertion of the arms of the motorcycle rider;
a plurality of channels formed on the arms and side panels of the garment, said channels defined by an exterior transparent longitudinal wall;
a plurality of LED strips, having a plurality of LED lights affixed thereto, said LED strips selectively slidably engageable in said selective channels formed on said arms and said side panel of said garment, said LED strips having a means for communication with a power source for illumination of said LEDs, said LEDs visible through said transparent longitudinal wall;
a power source for said LED strips; and
a control means for selectively controlling the lighting, frequency, and sequencing of said illumination of said LED strips.

2. The garment in accordance with claim 1 wherein said plurality of channels formed on the arms and side panels of the garment are defined by an exterior perforated see-through mesh material allowing for the visibility of the illuminated LEDs.

3. The garment in accordance with claim 1 wherein said power source comprises a rechargeable lithium ion battery positioned in a storage pocket formed on said garment, said communication means from said LED strips in electrical communication with said power source and said control means.

4. The garment in accordance with claim 1 wherein said power source comprises the battery of a motorcycle, said garment having secured thereto a communication means in the form of an electrical harness in communication with said LED strips and said control means, said electrical harness securable to said battery of said motorcycle.

5. The garment in accordance with claim 1 wherein said communication means of said LED strips comprises electrical conduit which is threadedly secured from the exterior LED strips through fabric of said garment to the interior of said garment and thence to said control means and said power source.

6. The garment in accordance with claim 4 wherein said garment contains additional channels formed on the rear surface of said garment for receipt of additional LED strips providing additional illumination of the rider rearwardly, said LED strips when powered by said harness and said motorcycle battery, being further responsive to the turn signals and brake signals of the motorcycle providing additional rearward warning, as well as illumination.

7. The garment in accordance with claim 1 wherein said LED strips may be quickly and facilely disconnected and removed from said channels to permit the cleaning of said garment.

8. The garment in accordance with claim 1 wherein the illumination color of said LEDs on said LED strips may be of any suitable color so as to improved the identification and direction of said motorcyclist.

9. A garment with illumination safety features to identify the location and direction of travel of an individual, the garment comprising:
a garment formed with a front panel, rear panel, and side panels covering the torso of the individual;
a plurality of channels formed on the arms and side panels of the garment, said channels defined by an exterior transparent longitudinal wall;
a plurality of LED strips, having a plurality of LED lights affixed thereto, said LED strips selectively slidably engageable in said selective channels formed on said arms and said side panel of said garment, said LED strips having a means for communication with a power source for illumination of said LEDs, said LEDs visible through said transparent longitudinal wall;
a power source for said LED strips; and
a control means for selectively controlling the lighting, frequency, and sequencing of said illumination of said LED strips.

10. The garment in accordance with claim 1 wherein said plurality of channels formed on the arms and side panels of the garment are defined by an exterior perforated see-through mesh material allowing for the visibility of the illuminated LEDs.

11. The garment in accordance with claim 9 wherein said power source comprises a rechargeable lithium ion battery positioned in a storage pocket formed on said garment, said communication means from said LED strips in electronic communication with said power source and said control means.

12. The garment in accordance with claim 9 wherein said communication means of said LED strips comprises electrical conduit which is threadedly secured from the exterior LED strips through fabric of said garment to the interior of said garment and thence to the control means and power source.

13. The garment in accordance with claim 9 wherein said garment contains additional channels formed on the rear surface of said garment for receipt of additional LED strips providing additional illumination of the individual rearwardly.

14. The garment in accordance with claim 9 wherein said LED strips may be quickly and facilely disconnected and removed from said channels to permit the cleaning of said garment.

15. The garment in accordance with claim 9 wherein the illumination color of said LEDs on said LED strips may be of any suitable color so as to improved the identification and direction of said motorcyclist.

16. A garment with illumination safety features to identify the location and direction of travel of an individual, the garment comprising:
a belt member to be worn about the waist of an individual;
two over the shoulder suspender members, one for each shoulder, the ends of which are secured to the front and rear of the said belt member;
a plurality of LED strips having a plurality of LED lights affixed thereto, said LED strips selective slidably enagageable in selective channels formed on said belt and said suspender members, said LED strips having a means for communication with a power source for illumination of said LEDs, said LEDs visible through said transparent outer longitudinal wall of said channels;
a power source for said LED strips.

17. The garment with illumination safety features in accordance with claim 16 wherein said garment further comprises underarm straps selectively secured to the suspender straps under the armpit of the wearer, said underarm straps also formed with a channel for receipt of an LED strip having LED lights affixed thereto.

18. The garment with illumination safety features in accordance with claim 16 wherein said garment further comprises a control means for selectively controlling the LEDs frequency and sequencing of illumination.

19. The garment with illumination safety features in accordance with claim 16 wherein said power source comprises a rechargeable lithium ion battery positioned in a storage pocket formed on said garment and in communication with said LED strips and said control means.

20. The garment with illumination safety features in accordance with claim 16 wherein said LED strips may be quickly and facilely disconnected and removed from said channels to permit said cleaning of said garment.
